(19) United States
(12) Patent Application Publication
(10) Pub. No.: US 2018/0171933 A1
(43) Pub. Date: Jun. 21, 2018

(54) MICROPUMP-FED AUTOGENOUS PRESSURIZATION SYSTEM

(71) Applicant: Flight Works, Inc., Irvine, CA (US)

(72) Inventor: Eric G. Besnard, Irvine, CA (US)

(21) Appl. No.: 15/384,083

(22) Filed: Dec. 19, 2016

(51) Int. Cl. F02K 9/46; F02K 9/60; F02K 9/56; F02K 9/58; F02K 9/62; F02K 9/97; B64G 1/40

(52) U.S. Cl. CPC F02K 9/46; F02K 9/605; F02K 9/563; B64G 1/401; F02K 9/62; F02K 9/97; B64G 1/402; F02K 9/58

(57) ABSTRACT

An autogenous system for controlling pressurization of a propellant tank in a pressure-fed propulsion system. The system includes at least one micropump that pumps a high vapor pressure liquid propellant or a propellant with low temperature critical point from the propellant tank into an engine in which a small portion of the propellant is evaporated and heated. The micropump controls a pressurization rate of a flow of the propellant. A method of controlling pressurization of a propellant tank in such a system includes pressurizing a propellant tank containing a high vapor pressure liquid propellant or a propellant with low temperature critical point; controlling a flow of a small amount of the propellant from the propellant tank to a combustion chamber using at least one micropump; heating and vaporizing the propellant in a heat exchanger; and using the micropump to control the amount of propellant vaporized and heated, thereby controlling the pressurization rate.

### BACKGROUND OF THE INVENTION

The invention relates to a system, method, and apparatus for controlling pressurization of pressure-fed rocket and spacecraft propellant tanks.

The simplest approach for pressurizing the propellant tanks in a pressure-fed propulsion system is based on having a large amount of ullage. In this approach, the tanks are initially partially filled with propellant, typically 40 to 60%, with the balance consisting of a pressurization gas, such as helium or nitrogen. This large initial pressurant volume fraction is dictated by the need to have adequate feed pressure as the propellants are depleted. For example, under isothermal conditions, with an initial propellant load of 50%, the final pressure in the tank is half of the initial pressure. This approach leads to large, heavy tanks since they have to be designed for the initial pressure. Also, this approach does not allow for control of the tank pressure profile, and therefore thrust.

To circumvent these drawbacks, the typical approach for pressurizing the propellant in tanks in a pressure-fed propulsion system involves using a separate, very high pressure gas supply, which is fed to the propellant tanks in order to fill with gas the volumes vacated by the depleted propellants. For example, helium is usually used with cryogenic propellants such as liquid oxygen and methane. The pressurant gases are stored at very high pressures, typically thousands of pounds per square inch, and are fed via check-valves and pressure regulator(s) to the propellant tanks at pressures typically in the hundreds of pounds per square inch. As a result, these systems are heavy, complex, expensive, and prone to component failures. Because this approach allows for the propellant tanks to be almost completely filled, for the same amount of propellant, this so-called regulated system is usually lighter than those relying on ullage.

The amount of pressurant gas needed can be reduced by heating it, such as via a heat exchanger by the engine, or by employing a Tridyne™ system. In the Tridyne™ system, traces of oxygen and hydrogen are mixed in helium at levels which do not make the pressurant flammable. The mixture is then run over a catalyst bed, triggering the combustion of hydrogen and oxygen which heats up the helium. These high pressure systems are expensive, heavy, and add complexity and risks of leakage, particularly over long missions.

For high vapor pressure propellants, another approach is to condition the propellants at their saturation conditions, using the so-called VaPak approach. This type of system presents many drawbacks which make it impractical for the desired applications. These drawbacks include suboptimal propellant packaging (due to the elevated temperature and therefore reduced liquid density leading to larger tanks), challenging propellant thermal control (in order to keep the system at the desired operating pressure), and two-phase flows in the feed system and injector leading to combustion instabilities.

U.S. Pat. No. 5,471,833 describes yet another approach that can be used to pressurize high vapor pressure propellants for rocket and space engine applications. The approach is based on separate, high pressure tanks that contain high vapor pressure liquids and multiple control valves. This system, while potentially providing a reduction in system mass when compared with the typical pressure-fed systems described above, requires a separate fluid system and utilizes multiple control components. These separate components add weight and complexity, and can cause reliability challenges.

It is an object of the invention to provide an autogenous system for controlling pressurization of pressure-fed rocket and spacecraft propellant tanks.

It is another object of the invention to provide such an autogenous system through which the tank pressure profile, and therefore thrust, and can be controlled.

It is a further object of the invention to provide such an autogenous system that is lightweight, simpler, less expensive, and less prone to component failures than previously known pressurization systems.

### SUMMARY OF THE INVENTION

The systems described herein accomplish the controlled pressurization of pressure-fed rocket and spacecraft propellant tanks using high vapor pressure liquid propellants, or propellants with low temperature critical point, in combination with one or more micropumps. During rocket or spacecraft engine operations, a small amount of liquid propellant is pumped, evaporated and heated in the engine to pressurize the propellant tank. The pump, which is an electrically driven micropump, provides control over the pressurization rates. In principle, this concept is similar to the autogenous pressurization system approach that can be used when turbopumps are available, but provides here a pressurization mechanism for pressure-fed propulsion systems employing high vapor pressure propellants. The micropumps can also be used for propellant management and center of gravity control when multiple tanks are used instead of having to rely on passive systems to move fluids from tank to tank. Additional micropumps can also be used in the system in conjunction with condensers for pressurizing the liquid after the liquid has been cooled by expansion.

The invention takes advantage of the development of high energy density micropumps and additive manufacturing technologies for high efficiency heat exchangers that can be integrated into rocket and spacecraft engines, to create a truly autogenous system. Consequently, the need for all high pressure tanks and associated components is eliminated. This approach has many advantages, the main advantages being reduced system mass, both wet mass and dry mass, and reduced complexity. In addition to increasing reliability, owing to the simplicity of the system, this system drastically reduces acquisition and operational costs. Furthermore, the micropump can be used to indirectly throttle the rocket engine since the micropump controls pressurant flow. This feature allows the thrust profile to be tailored in order to optimize the trajectory of a rocket or spacecraft.

In particular, an autogenous system for controlling pressurization of a propellant tank in a pressure-fed propulsion system may include at least one micropump that pumps a high vapor pressure liquid propellant, or a propellant with low temperature at its critical point, from the propellant tank into an engine in which the propellant is evaporated and heated. The micropump controls the pressurization rate by controlling the flow of the propellant being evaporated and heated. The system may also include a low power heater in the propellant tank in order to heat the gaseous or supercritical propellant, if needed. The system may additionally include a propellant conditioning loop with an auxiliary micropump used in a condenser to pressurize the propellant after the propellant has been cooled by expansion.

According to certain embodiments of the system, the propellant may flow from the propellant tank through a conduit to a main valve, which diverts a portion of the propellant to the micropump which controls the pressurization rate of the flow of the propellant to a heat exchanger on a combustion chamber, and the main valve directs a remainder of the propellant to an injector, wherein the propellant in the injector combusts into the combustion chamber and expands into a nozzle. The heat exchanger on the combustion chamber vaporizes the propellant, and an output flow of vaporized propellant leaves the heat exchanger and enters a supply line back to the propellant tank. Furthermore, a portion of the output flow of vaporized propellant that leaves the heat exchanger may be injected back into the combustion chamber.

The propellant used in the system may include, for example, oxygen, methane, propylene, propane, or combinations thereof.

The system may be a mono-propellant system or a bi-propellant system, such as with a fuel and an oxidizer.

A rocket engine may include any of the systems described herein.

A spacecraft engine may also include any of the systems described herein.

A method of controlling pressurization of a propellant tank in a pressure-fed propulsion system includes the steps of pressurizing a propellant tank containing a high vapor pressure liquid propellant; controlling a flow of the propellant from the propellant tank to a combustion chamber using at least one micropump; heating and vaporizing the propellant in the combustion chamber; and using the micropump(s) to control a pressurization rate of the flow of the propellant. As noted above, at least some of the flow of the vaporized propellant may be directed back to the combustion chamber.

According to certain embodiments, the propellant tank may be pre-pressurized with an inert gas. Additionally or alternatively, the propellant tank may be pre-pressurized by heating the propellant vapors.

### BRIEF DESCRIPTION OF THE DRAWINGS

The accompanying drawings, which are incorporated in and constitute a part of this specification, illustrate embodiments of the invention and, together with the description, serve to explain the features, advantages, and principles of the invention. In the drawings:

FIG. 1 is a diagram of a pump-fed autogenous system with the entire heat exchanger output flow used for pressurization.

FIG. 2 is a diagram of a pump-fed autogenous system with partial heat exchanger output flow used for pressurization.

FIG. 3 is a diagram of a thrust chamber and pump system with partial or entire heat exchanger output flow being injected in a combustion chamber.

FIG. 4 is an enlarged view of a diagram of a thrust chamber with partial or full heat exchanger output flow being injected in a combustion chamber.

FIG. 5 is a diagram of a pump-fed autogenous system with a propellant conditioning loop.

FIG. 6 is a diagram of a tank diffuser.

FIG. 7 is a diagram of one embodiment of heat exchangers on a combustion chamber.

FIG. 8 is a diagram of another embodiment of heat exchangers on a combustion chamber.

FIG. 9 is a diagram of yet another embodiment of heat exchangers on a combustion chamber.

### DETAILED DESCRIPTION OF THE INVENTION

The autogenous system for controlling pressurization of a propellant tank in a pressure-fed propulsion system may be either a monopropellant system, using a single propellant, or a bipropellant system, using at least two separate propellants such as a fuel and an oxidizer. As used herein, the term “autogenous” refers to a system that can function in an essentially closed loop with minimal assistance from external components. In a bipropellant system herein, the two propellants are maintained in primarily separate loops, but for their combined use in a combustion chamber, as described in further detail below.

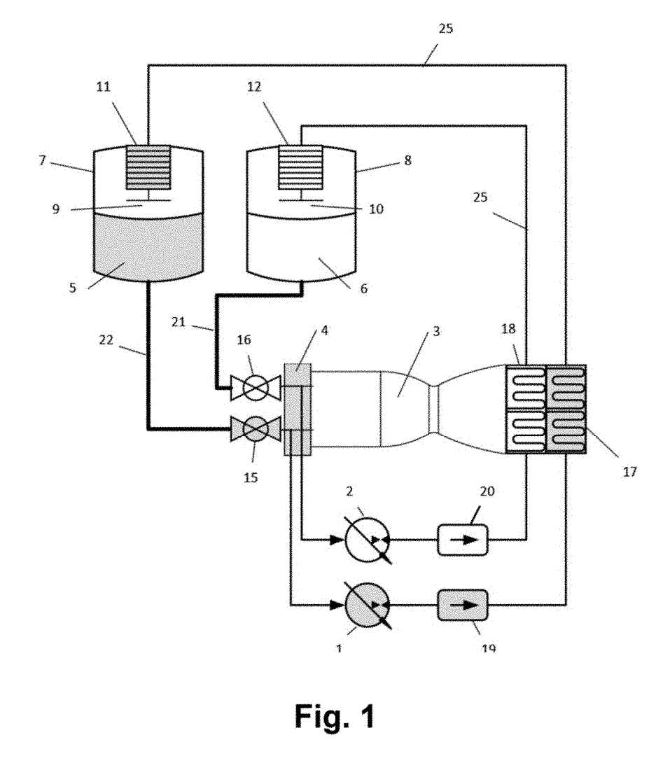

FIG. 1 shows a bipropellant pump-fed autogenous system including a micropump 2 that pumps a propellant or fuel 6 from a propellant tank or fuel tank 8 into a combustion chamber 3 of an engine, such as a rocket engine, in which the propellant or fuel 6 is evaporated and heated. The micropump 2 controls the pressurization rate by controlling the flow of the fuel 6.

The system in FIG. 1 also includes a second micropump 1 that pumps another propellant or oxidizer 5 from another propellant tank or oxidizer tank 7 into the combustion chamber 3 in which the oxidizer 5 is evaporated and heated. The second micropump 1 controls the pressurization rate by controlling the flow of the oxidizer 5.

More particularly, the fuel 6 flows from the fuel tank 8 through a conduit 21 to a main valve 16. An opening upstream of the main valve 16 diverts a portion of the fuel 6 to the micropump 2, which controls the pressurization rate of the flow of the fuel 6 to a heat exchanger 18 on the combustion chamber 3. The main valve 16 directs a remainder of the fuel 6 to an injector 4. The fuel 6 in the injector 4 combusts with the oxidizer 5 into the combustion chamber 3 and expands into a nozzle, which propels the rocket or spacecraft. The heat exchanger 18 on the combustion chamber 3 vaporizes the fuel 6, and an output flow of vaporized fuel leaves the heat exchanger 18 and enters a supply line 25 back to the fuel tank 8.

Likewise, the oxidizer 5 flows from the oxidizer tank 7 through a conduit 22 to a main valve IS. An opening upstream of the main valve 15 diverts a portion of the oxidizer 5 to the micropump 1, which controls the pressurization rate of the flow of the oxidizer 5 to a heat exchanger 17 on the combustion chamber 3. The main valve 15 directs a remainder of the oxidizer 5 to the injector 4. The oxidizer 5 in the injector 4 combusts into the combustion chamber 3 where it mixes with the fuel 6, and the mixture expands into the nozzle, which propels the rocket or spacecraft. The heat exchanger 17 on the combustion chamber 3 vaporizes the oxidizer 5, and an output flow of vaporized oxidizer leaves the heat exchanger 17 and enters a supply line 25 back to the oxidizer tank 7.

The system may also include a check valve 20 between the micropump 2 and the heat exchanger 18, as well as a check valve 19 between the micropump 1 and the heat exchanger 17, in order to prevent a backflow of gaseous or supercritical propellant into the micropumps 1, 2.

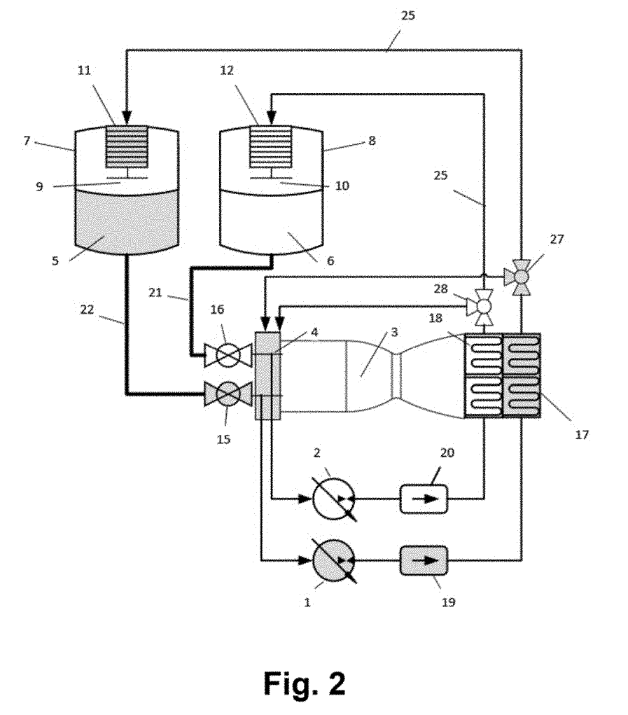

The entire heat exchanger output flow may be used for pressurization, as shown in FIG. 1. Alternatively, part of the heat exchanger output flow may be used for pressurization while a remainder of the heat exchanger output flow is injected into the combustion chamber 3, as shown in FIG. 2.

FIG. 2 includes the same components as in FIG. 1, with the addition of a three-way proportional valve 28, or the equivalent, that accepts the output flow of vaporized fuel leaving the heat exchanger 18 and directs the flow partially to the supply line 25 back to the fuel tank 8 and partially back to the combustion chamber 3. FIG. 2 also includes a three-way proportional valve 27, or the equivalent, that accepts the output flow of vaporized oxidizer leaving the heat exchanger 17 and directs the flow partially to the supply line 25 back to the oxidizer tank 7 and partially back to the combustion chamber 3. The three-way valves 27, 28 may be adjusted as deemed necessary or desirable, directing more or less of the output flow back to the propellant tanks 7, 8 and more or less of the output flow back to the combustion chamber 3.

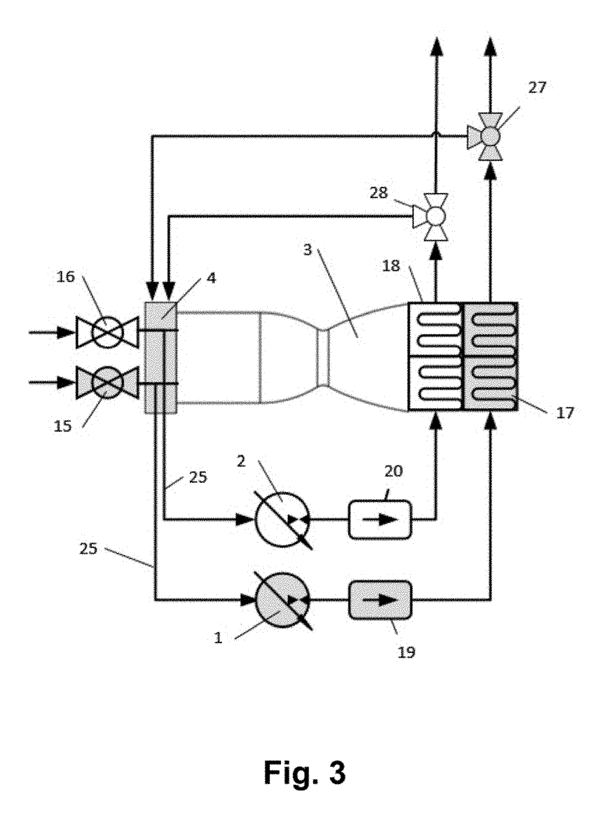

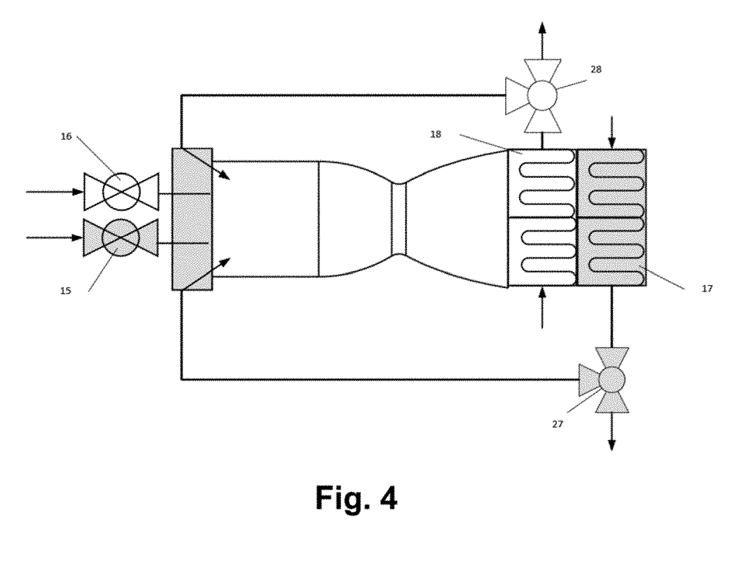

An enlarged view of the combustion chamber 3 and pump system with some or all of the heat exchanger output flow being injected into the combustion chamber 3 is shown in FIG. 3. FIG. 4 shows an even closer view of the combustion chamber 3 with some or all of the heat exchanger output flow being injected into the combustion chamber 3. The pump system is not included in FIG. 4 in order to focus exclusively on the combustion chamber 3 and its return loops.

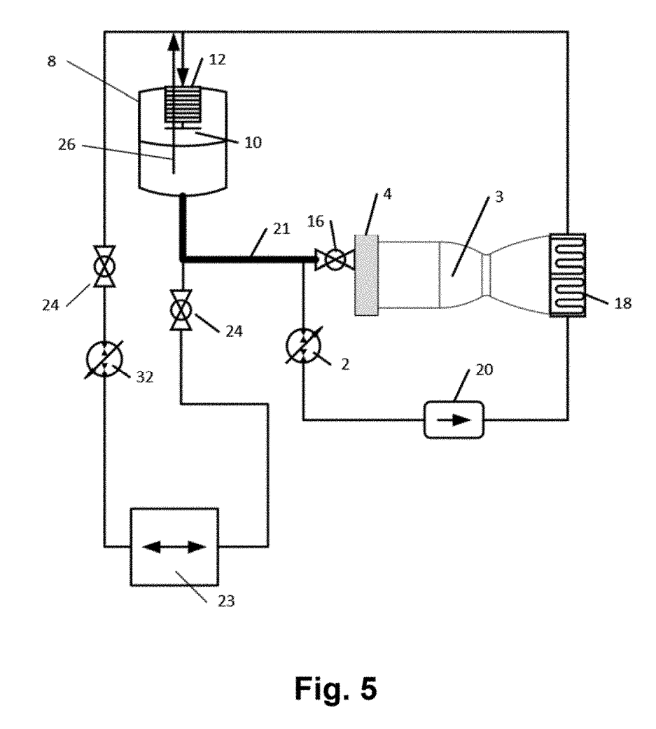

A monopropellant system is shown in FIG. 5. The system in FIG. 5 is very similar to the fuel system of FIG. 1, with the addition of a propellant conditioning loop. The propellant conditioning loop includes a cooler that uses an auxiliary micropump 32 to drive the propellant 6 flow. More particularly, the conditioning loop includes a propellant pick-up line 26 within the propellant tank 8, which draws the propellant 6 from the propellant tank 8 to an auxiliary micropump 32. A valve 24 positioned between the propellant pick-up line 26 and the auxiliary micropump 32 may control how much, if any, of the propellant 6 passes to the auxiliary micropump 32. The auxiliary micropump 32 controls the flow of the propellant 6 as the propellant 6 passes into a cooling unit 23. After exiting the cooling unit 23, the cooled propellant is directed back to the propellant tank 8, with an optional valve 24 controlling how much of the propellant 6 passes into the propellant tank 8. A propellant conditioning loop may be included for each propellant in a bipropellant system, such as a fuel conditioning loop and an oxidizer conditioning loop.

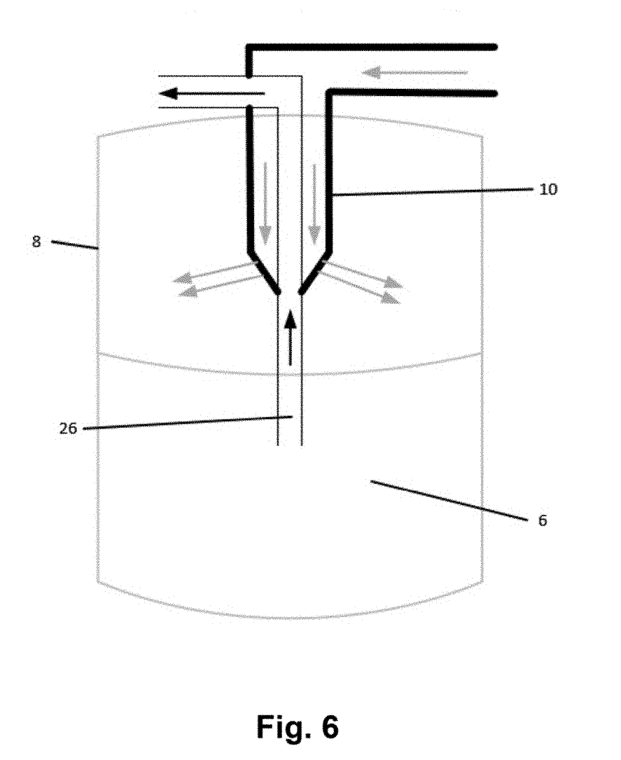

FIG. 6 illustrates the propellant flow into and out of the propellant tank 8. More particularly, each tank 8 may include a diffuser 9, 10, which is illustrated in FIGS. 1, 2, and 4 as well. The diffuser 10 slows down the incoming gas that enters the tanks 7, 8 through the supply lines 25. As described above with respect to FIG. 5, liquid propellant 6 is removed from the tank 8 through the propellant pick-up line 26 for propellant temperature conditioning. The gas and liquid should be maintained as separate phases in the propellant tanks 7, 8, to ensure that liquid propellant is directed to the micropumps 1, 2.

A heater 11, 12, such as a low-power, electric heater, may be included in each of the propellant tanks, 7, 8 to further control the gaseous or supercritical propellant temperature, if needed. A case where such heater might be needed would be after extended non-operations of the rocket or spacecraft engine when the pressurant gas was allowed to cool down. The temperature range within the tanks 7, 8 may vary depending on the actual propellant, but in general may range between about −260 and about −50° C.

When a rocket or other space vehicle is in space, starting an engine can be challenging. Initial pressure is needed to start the engine. Conventional systems often use helium to pre-pressurize a propellant tank, particularly when there is a small volume of liquid propellant at a low temperature and low pressure. As used herein, the term “pre-pressurize” refers to pressurization prior to turning on an engine. The present system may also be started using helium or other inert gas, such as nitrogen, to pre-pressurize the propellant tank. The inert pressurant gas may be stored at a pressure between about 2000 psia (14 MPa) and about 10,000 psia (69 MPa), for example. Storing high-pressure gases, even in composite overwrapped pressure vessels (COPV), presents risks, such as potential stress ruptures. Not to mention, the storage vessels for high-pressure gases are necessarily heavy, adding considerable weight to the overall system.

To overcome the challenge of starting an engine without the addition of helium or other inert gas, and when there is a small volume of liquid propellant at a low temperature and low pressure, a small heater 11, 12 in each of the tanks 7, 8 can be used to increase pressure within the tanks 7, 8 in order to start the circuits. By manipulating the pressure of one or both of the propellants, the system can be started without mixing propellants, thereby lowering the risk of any adverse reactions involving the propellants. The heaters 11, 12 may increase the temperature of the gases within the tanks 7, 8 by a few degrees to reach the desired start-up pressure. Right before or after the engine starts, the heaters 11, 12 can be turned off.

The propellant 6 or propellants 5, 6 used in the system include high vapor pressure oxidizers and fuels, and propellants with low temperature critical point, such as oxygen, nitrous oxide, hydrogen, methane, propylene, propane, and combinations thereof. As used herein, the term “high vapor pressure propellant” refers to propellants with vapor pressures in the range of typical pressure-fed systems when at practical gas temperatures. Typical pressures in pressure-fed systems range from a few tens of psi, for example 50 psi, to about 2,000 psi, with most pressure-fed systems operating below 500 psi. Practical gas temperatures correspond to temperatures at which a propellant can be stored with materials used for the construction of the system. For most propellants the temperature limit is around 100° C. Propellants with low temperature critical point refer to propellants where the critical point temperature is below ambient temperature; more particularly, where at ambient temperature, the propellants are either in a gas or supercritical state.

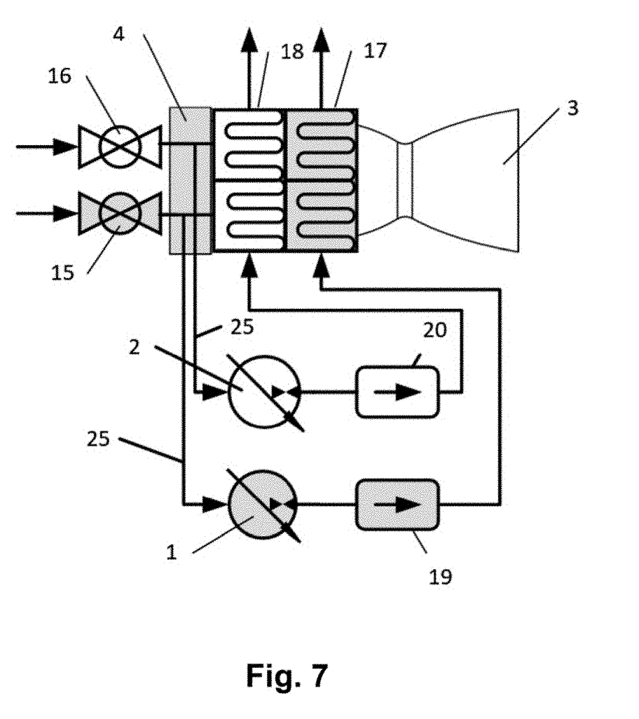

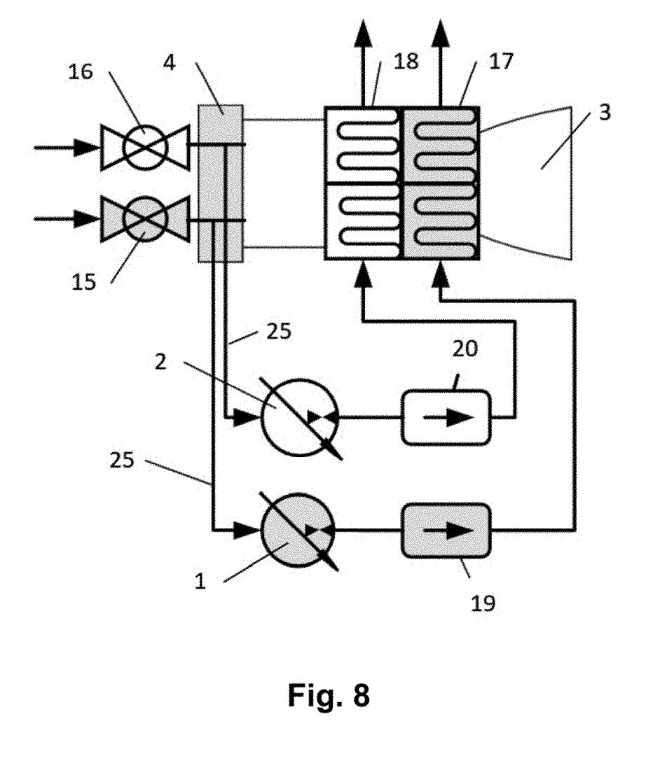

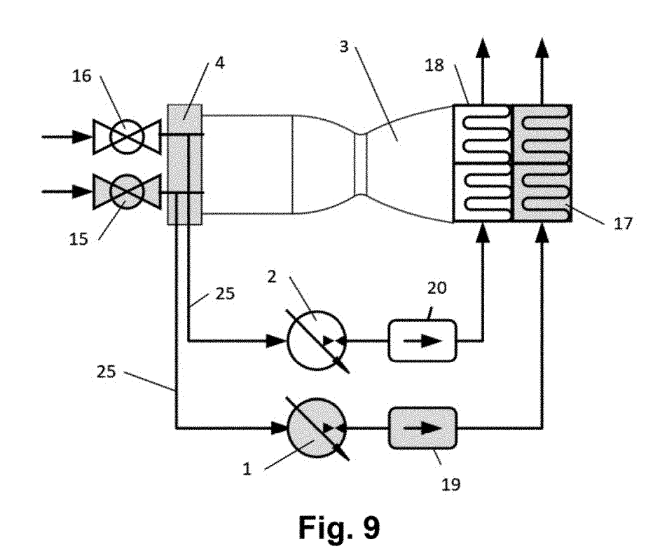

The heat exchangers 17, 18 can be located in various positions on the combustion chamber 3. As shown in FIG. 7, the heat exchangers 17, 18 may be located in close proximity to the injector 4. FIG. 8 shows the heat exchangers 17, 18 located in a middle section of the combustion chamber 3, near a throat of the combustion chamber 3 where heat transfer rates are the highest. FIG. 9, like FIGS. 1-5, shows the heat exchangers 17, 18 located nearest a nozzle exit of the combustion chamber 3. Regardless of the position of the heat exchangers 17, 18 on the combustion chamber 3, the function of the heat exchangers 17, 18 remains the same. For example, the mass and volume of the gas output from the heat exchangers 17, 18 are essentially the same regardless of position.

In contrast with turbo pumps, the micropumps 1, 2, 32 used in the present systems are externally-driven pumps having relatively small dimensions. A turbo pump refers to one or more pump sections that are driven by a turbine, which is driven by the combustion of some fluids, often the propellants themselves. As used herein, the term “micropump” refers to an electrically-driven displacement pump. The term “micro” refers to the fact that a small portion of the rocket engine flow rate (typically less than 5%) goes through the pump as opposed to a turbo pump-fed system where the entire flow rate goes through the pump; this allows the micropump to be smaller. For example, the micropumps 1, 2, 32 may have a diameter between about 13 and about 100 mm, or between about 20 and about 80 umm, or between about 22 and about 50 mm, and a length between about 5 and about 15 cm, or between about 6 and about 12 cm, or between about 8 and about 10 cm. The capacity or output of the micropumps 1, 2, 32 can be between about 200 ml/min and about 100 L/min, or between about 500 ml/min and about 5 L/min, or between about 750 ml/min and about 1.2 L/min, for example. M-Series magnetic drive gear pumps, available from Flight Works, Inc., of Irvine, Calif., are examples of suitable micropumps for use in the present systems. A small percentage of flow, such as 0.5% to 4% by weight of the primary propellant, for example, results in a small pressure increase, which is sufficient to maintain the function of the autogenous system. By minimizing the propellant flow, the overall size and weight of the system can be drastically reduced compared to known propulsion systems.

A rocket engine, spacecraft engine, or other pressure-fed propulsion systems, such as launch vehicles or other systems, may include the autogenous system for controlling pressurization of a propellant tank in a pressure-fed propulsion system, as described herein. Furthermore, one or more of the micropumps 1, 2, 32 can be used to control a center of gravity of the system when multiple tanks are used for each propellant, as is often the case for large robotic and human spacecraft, by pumping propellant from one tank to the other.

While controlling pressurization of the propellant, the micropumps 1, 2, 32 can also be used to indirectly throttle the rocket or spacecraft engine through the control of the pressurant flow. This control over the pressure allows tailoring of the thrust profile in order to optimize the trajectory of a rocket or spacecraft.

A method of pressurizing a propellant tank, in accordance with the teachings herein, includes the steps of pressurizing a propellant tank 8 containing a high vapor pressure or low temperature critical point liquid propellant 6; controlling a flow of the propellant 6 from the propellant tank 8 to a combustion chamber 3 using at least one micropump 2; heating and vaporizing the propellant 6 in the combustion chamber 3; and using the micropump 2 to control a pressurization rate of the flow of the propellant 6. While the system is running, some or all of the flow of the vaporized propellant may be directed back to the combustion chamber 3, while some or all of the flow of the vaporized propellant may be directed back to the propellant tank 8. As described above, an inert gas may be used to pre-pressurize the propellant tank 8. Alternatively, or additionally, the propellant tank 8 may be pre-pressurized by heating the propellant vapors.

It will be apparent to those skilled in the art that various modifications and variations can be made in the disclosed structures and methods without departing from the scope or spirit of the invention. Particularly, descriptions of any one embodiment can be freely combined with descriptions or other embodiments to result in combinations and/or variations of two or more elements or limitations. Other embodiments of the invention will be apparent to those skilled in the art from consideration of the specifications and practice of the invention disclosed herein. It is intended that the specification and examples be considered exemplary only, with a true scope and spirit of the invention being indicated by the following claims.

1. An autogenous system for controlling pressurization of a propellant tank in a pressure-fed propulsion system, the system comprising:
at least one micropump that pumps a high vapor pressure liquid propellant or a propellant with low temperature critical point from the propellant tank into an engine in which the propellant is evaporated and heated;
wherein the at least one micropump controls a pressurization rate of a flow of the propellant.

2. The autogenous pressurization system of claim 1, further comprising a heater in the propellant tank.

3. The autogenous pressurization system of claim 2, comprising a plurality of propellant tanks, wherein the micropump can control a center of gravity of the system.

4. The autogenous pressurization system of claim 2, further comprising an auxiliary micropump used in a cooler to drive the propellant before the propellant gets cooled.

5. The autogenous pressurization system of claim 1, wherein the propellant flows from the propellant tank through a conduit upstream of a main valve, which diverts a portion of the propellant to the micropump which controls the pressurization rate of the flow of the propellant to a heat exchanger on a combustion chamber, and the main valve directs a remainder of the propellant to an injector, wherein the propellant in the injector combusts into the combustion chamber and expands into a nozzle;
the heat exchanger on the combustion chamber vaporizes and heats the propellant; and
an output flow of vaporized, heated propellant leaves the heat exchanger and enters a supply line back to the propellant tank.

6. The autogenous pressurization system of claim 5, wherein at least a portion of the output flow of vaporized, heated propellant leaves the heat exchanger and is injected back into the combustion chamber.

7. The autogenous pressurization system of claim 5, wherein the propellant is selected from the group consisting of oxygen, nitrous oxide, hydrogen, methane, propylene, propane, and combinations thereof.

8. A rocket engine comprising the system of claim 1.

9. A spacecraft engine comprising the system of claim 1.

10. An autogenous system for pressurizing a propellant tank, comprising:
a fuel stored in a fuel tank;
an oxidizer stored in an oxidizer tank;
a first conduit connecting the fuel tank to a first conduit that diverts a portion of a flow of the fuel to a first micropump that controls a pressurization rate of a flow of the fuel to a first heat exchanger on a combustion chamber, and a first main valve directs a remainder of the flow of the fuel to an injector, wherein the fuel in the injector mixes with the oxidizer and combusts into the combustion chamber and expands into a nozzle;
a second conduit connecting the oxidizer tank to a second conduit that diverts a portion of a flow of the oxidizer to a second micropump that controls a pressurization rate of a flow of the oxidizer to a second heat exchanger on the combustion chamber, and a second main valve directs a remainder of the flow of the oxidizer to the injector, wherein the oxidizer in the injector mixes with the fuel and combusts into the combustion chamber and expands into the nozzle;
the first heat exchanger on the combustion chamber vaporizes and heats the fuel and an output flow of vaporized, heated fuel leaves the first heat exchanger and enters a supply line back to the fuel tank; and
the second heat exchanger on the combustion chamber vaporizes and heats the oxidizer and an output flow of vaporized, heated oxidizer leaves the second heat exchanger and enters a supply line back to the oxidizer tank.

11. The autogenous pressurization system of claim 10, further comprising a heater in the fuel tank.

12. The autogenous pressurization system of claim 10, further comprising a heater in the oxidizer tank.

13. The autogenous pressurization system of claim 10, wherein at least a portion of the output flow of vaporized, heated fuel leaves the first heat exchanger and is injected back into the combustion chamber.

14. The autogenous pressurization system of claim 10, wherein at least a portion of the output flow of vaporized, heated oxidizer leaves the second heat exchanger and is injected back into the combustion chamber.

15. The autogenous pressurization system of claim 10, wherein the system comprises a plurality of propellant tanks, and at least one of the micropumps can control a center of gravity of the system.

16. The autogenous pressurization system of claim 10, further comprising an auxiliary micropump used in a cooler to drive the fuel before the fuel gets cooled.

17. The autogenous pressurization system of claim 10, further comprising an auxiliary micropump used in a cooler to drive the oxidizer before the oxidizer gets cooled.

18. The autogenous pressurization system of claim 10, wherein the fuel is selected from the group consisting of oxygen, methane, propylene, propane, and combinations thereof.

19. The autogenous pressurization system of claim 10, wherein the oxidizer is selected from the group consisting of oxygen, nitrous oxide, hydrogen, methane, propylene, propane, and combinations thereof.

20. A rocket engine comprising the system of claim 10.

21. A spacecraft engine comprising the system of claim 10.

22. A method of controlling pressurization of a propellant tank in a pressure-fed propulsion system, comprising:
pressurizing a propellant tank containing a high vapor pressure liquid propellant or a propellant with low temperature critical point;
controlling a flow of the propellant from the propellant tank to a combustion chamber using at least one micropump;
heating and vaporizing the propellant in the combustion chamber; and
using the at least one micropump to control a pressurization rate of the flow of the propellant.

23. The method of claim 22, comprising pre-pressurizing the propellant tank with an inert gas.

24. The method of claim 22, comprising pre-pressurizing the propellant tank by heating the propellant vapors.

25. The method of claim 22, comprising directing at least some of the flow of the vaporized, heated propellant back to the combustion chamber.
